(19) United States
(12) Patent Application Publication
(10) Pub. No.: US 2011/0228392 A1
(43) Pub. Date: Sep. 22, 2011

(54) OPTICAL RETROREFLECTIVE APPARATUS AND METHOD THEREOF

(75) Inventors: Jauh-jung Yang, Taoyuan (TW); Chi-feng Chen, Taoyuan (TW)

(73) Assignee: DAYU optoelectronics, Taoyuan County (TW)

(21) Appl. No.: 12/790,127

(22) Filed: May 28, 2010

(30) Foreign Application Priority Data
Mar. 18, 2010 (TW) 099204786

(51) Int. Cl. G02B 5/124; B05D 5/06

(52) U.S. Cl. 359/530; 427/163.4

(57) ABSTRACT

An optical retroreflective apparatus and method thereof are described. The optical retroreflective apparatus includes a substrate, a first material layer, a first taper pattern layer, a reflecting layer, and a second material layer. The first material layer is formed on the substrate. The first taper pattern layer is formed on the first material layer wherein the first taper pattern layer has a plurality of first pyramidal units. The reflecting layer is formed on the first taper pattern layer wherein the reflecting layer has a plurality of reflecting patterns and each of the reflecting patterns is covered with each of first pyramidal units. The second material layer is formed on the reflecting layer wherein the second material layer has a second taper pattern layer having a plurality of second pyramidal units. The second taper pattern layer is covered with the reflecting layer and the second pyramidal units are filled with the spacing region between the reflecting patterns of the reflecting layer.

### CLAIM OF PRIORITY

This application claims priority to Taiwanese Patent Application No. 099204786 filed on Mar. 18, 2010.

### FIELD OF THE INVENTION

The present invention relates to a reflecting apparatus and method thereof, and more particularly to an optical retroreflective apparatus and method thereof wherein the optical retroreflective apparatus is applicable to the display device with touch screen.

### BACKGROUND OF THE INVENTION

Conventionally, a retroreflective strip sheet is used to reflect the incident light along the reverse direction of the incident direction to the light source transmitter/receiver wherein the light source transmitter and receiver are integrated into an electrical circuit. Generally, the transmitter and the receiver are disposed in upper position and lower position in the same region of the electrical circuit. When the transmitter issues the incident light to the retroreflective strip sheet, the receiver receives the transmitted incident light and such the reflection technique is applied to touch screen. Basically, two or three sets of light source transmitters/receivers are utilized which are located in the corners of the display frame of the touch screen and the retroreflective strip sheet is installed around the display frame. When the infrared rays (or the light having wave length of infrared rays) of each transmitter/receiver is issued to the retroreflective strip sheet, the reflected infrared rays return to the receiver of the retroreflective strip sheet. While the finger of the user touches the touch screen and stops the infrared rays from the transmitter and thus the infrared rays do not return the receiver, a relative dark region is formed in the region of the finger. That is, when the finger appear or disappear on the relative dark region to generate the change status of gray level so that coordinate of the finger can be calculated by the intersection region based on the infrared rays of the transmitters/receivers.

Please refer to FIG. 1. FIG. 1 is a schematic cross-sectional view of a conventional retroreflective strip sheet 100. The retroreflective strip sheet 100 includes a substrate 102, a taper patter layer 104, a reflecting metal layer 106, a plate 107 and the adhesive layer 109. The taper patter layer 104 has a plurality of pyramid shapes 104a. The taper patter layer 104 is formed on the substrate 102 and the reflecting metal layer 106 is coated on the taper patter layer 104 for reflecting the infrared ray 108 to be issued back to the receiver (not shown). The taper patter layer 104 is secured to the plate 107 by the reflecting metal layer 106. The retroreflective strip sheet 100 is boned to the display frame 110 by the adhesive layer 109.

The boned region between the taper patter layer 104 and the plate 107 is the contact region 114 formed by two sides of the reflecting metal layer 106 and the two sides of the plate 107. Further, the vertexes 112 of the pyramid shapes 104a slightly contact the plate 107. That is, the vertexes 112 of the pyramid shapes 104a do not adhere to the plate 107 and form a hollow region 111 near the vertex 112. Therefore, the bonding region between the taper patter layer 104 and the plate 107 is not secured. Additionally, when the bonding strength between the taper patter layer 104 and the plate 107 is not stable, the retroreflective strip sheet 100 will be deformed due to thermal expansion and cool contraction so that the reflected infrared rays cannot be correctly detected. In other words, when the bonding strength between the taper patter layer 104 and the plate 107 is poor, the retroreflective strip sheet 100 falls off from the display frame 110 and the touch position of the finger cannot be found.

Consequently, there is a need to develop a novel retroreflective strip sheet to solve the aforementioned problems of the bonding strength between the retroreflective strip sheet 100 and the display frame 110.

### SUMMARY OF THE INVENTION

The first objective of the present invention is to provide an optical retroreflective apparatus to form a material layer on the optical retroreflective apparatus to stably secure the optical retroreflective apparatus to the display frame of touch screen to prevent the optical retroreflective apparatus from the deformation so that the reflecting layer precisely reflects the incident light.

The second objective of the present invention is to provide an optical retroreflective apparatus to form a material layer on the reflecting layer to prevent the reflecting layer from oxidation.

According to the above objectives, the present invention sets forth the optical retroreflective apparatus. The optical retroreflective apparatus includes a substrate, a first material layer, a first tape pattern layer, a reflecting layer, and a second material layer. The first material layer is formed on the substrate and for example, the first material layer is a hardened resin layer. The first taper pattern layer is formed on the first material wherein the first taper pattern layer has a plurality of first pyramidal units. The reflecting layer is formed on the first taper pattern layer and covers the first pyramidal units wherein the reflecting layer has a plurality of reflecting patterns and each of the first pyramidal units is covered with each of the reflecting patterns. The second material layer is formed on the reflecting layer and the second material layer has a second taper pattern layer which is composed of a plurality of pyramidal units. The reflecting layer is covered with the second taper pattern layer and the second pyramidal units are correspondingly filled into the spacing region between the reflecting patterns of the reflecting layer for complementing the second pyramidal units with the first pyramidal units therebetween to form the optical retroreflective apparatus.

When the incident light is issued to the optical retroreflective apparatus, the incident light is transmitted to the anti-reflection function layer, the substrate and the first material layer sequentially and the reflecting patterns of the reflecting layer then reflects the transmitted incident light. Afterwards, the incident light passes through the first material layer, the substrate and the anti-reflection function layer in a reverse direction so that the incident light precisely reflects in the reverse direction which is opposite to the incident direction after the incident light is reflected by the reflecting patterns. Since the second material layer is closely adhered to the first material layer, the optical retroreflective apparatus is stably stuck to the display frame of a touch screen to prevent the optical retroreflective apparatus from the deformation. As a result, the reflected incident light can be used to detects the touch position on the touch screen when the reflecting layer precisely reflects the incident light.

According to the above-mentioned descriptions, the bonding status between the first material layer and the second material layer is performed by adhering the first taper pattern layer and the reflecting layer to the second taper pattern layer. Specifically, the geometry shapes of the first pyramidal units, reflecting patterns and the second pyramidal units are complementary to prevent the optical retroreflective apparatuses from the deformation. Furthermore, the optical retroreflective apparatuses in the present invention effectively increase the contact region between the first pyramidal units, the reflecting patterns and the second pyramidal units for improving the secured stability of the first material layer to the second material layer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic cross-sectional view of a conventional retroreflective strip sheet;

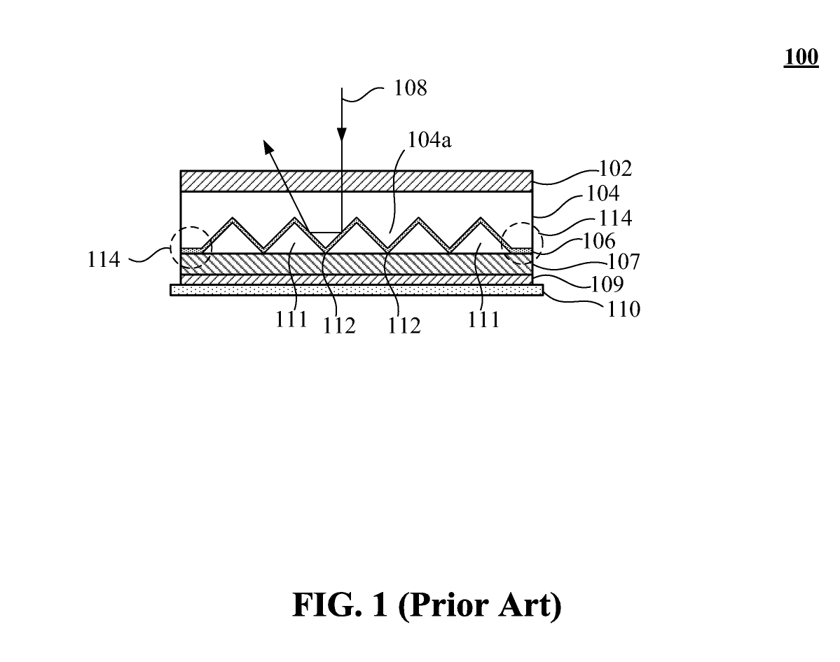

FIG. 2A is a schematic cross-sectional view of an optical retroreflective apparatus according to a first embodiment of the present invention;

FIG. 2B is a schematic cross-sectional view of an optical retroreflective apparatus according to a second embodiment of the present invention;

FIG. 2C is a schematic cross-sectional view of an optical retroreflective apparatus according to a third embodiment of the present invention;

FIG. 2D is a schematic cross-sectional view of an optical retroreflective apparatus according to a fourth embodiment of the present invention;

FIG. 2E is a schematic cross-sectional view of an optical retroreflective apparatus according to a fifth embodiment of the present invention;

FIG. 3 is a flow chart of manufacturing method of the optical retroreflective apparatuses shown in FIGS. 2A-2D according to one embodiment of the present invention; and

FIG. 4 is a flow chart of manufacturing method of the optical retroreflective apparatus shown in FIG. 2E according to one embodiment of the present invention.

### DETAILED DESCRIPTION OF THE PREFERRED EMBODIMENTS

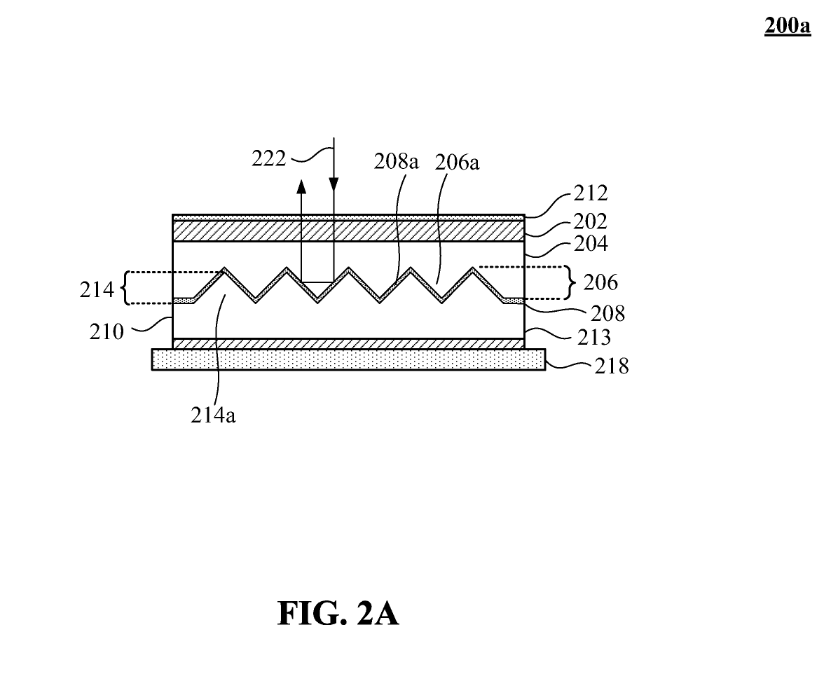

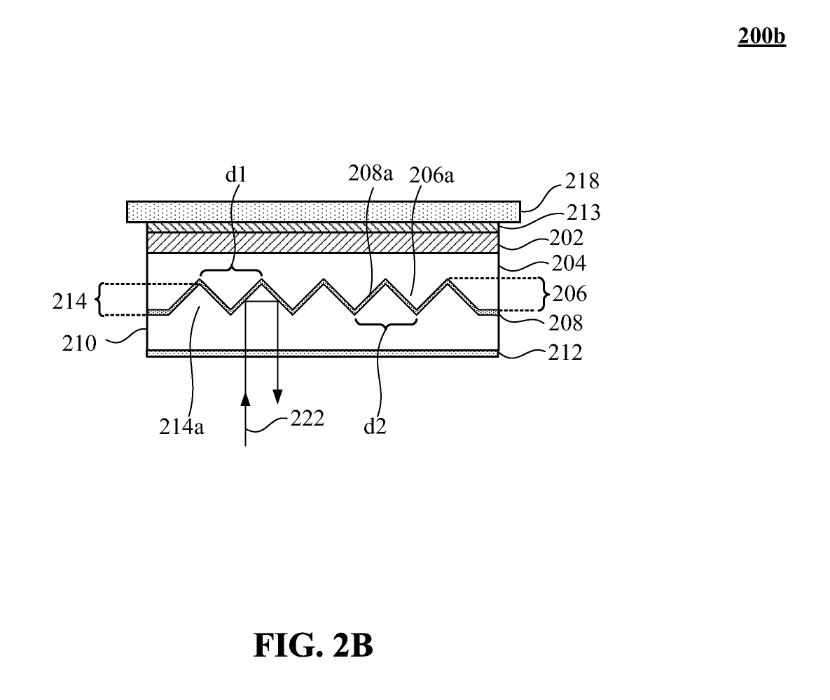

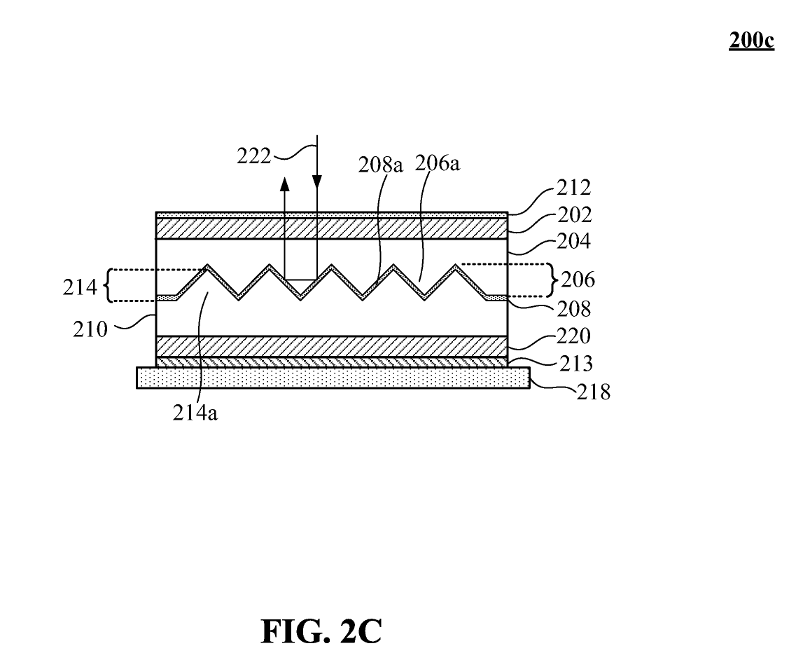

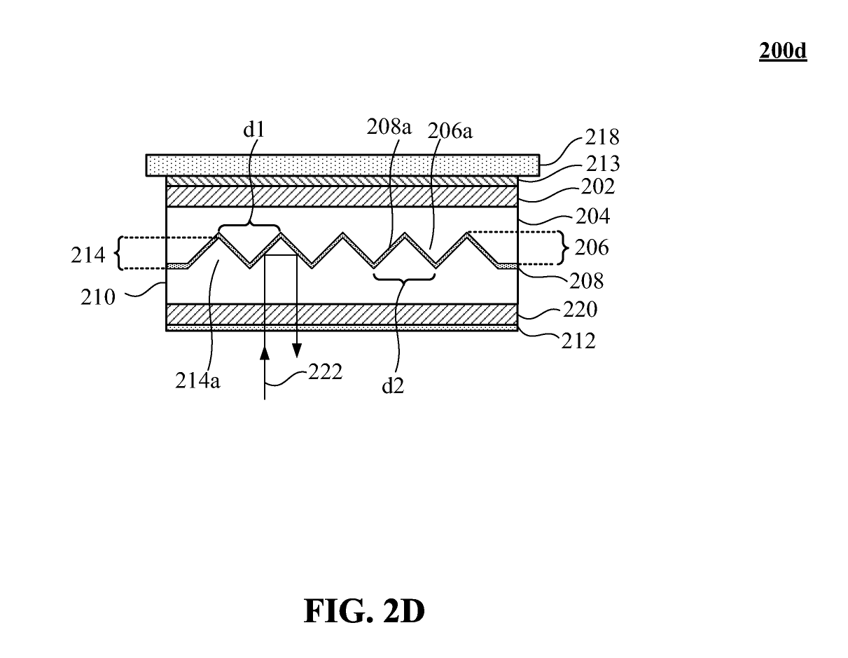

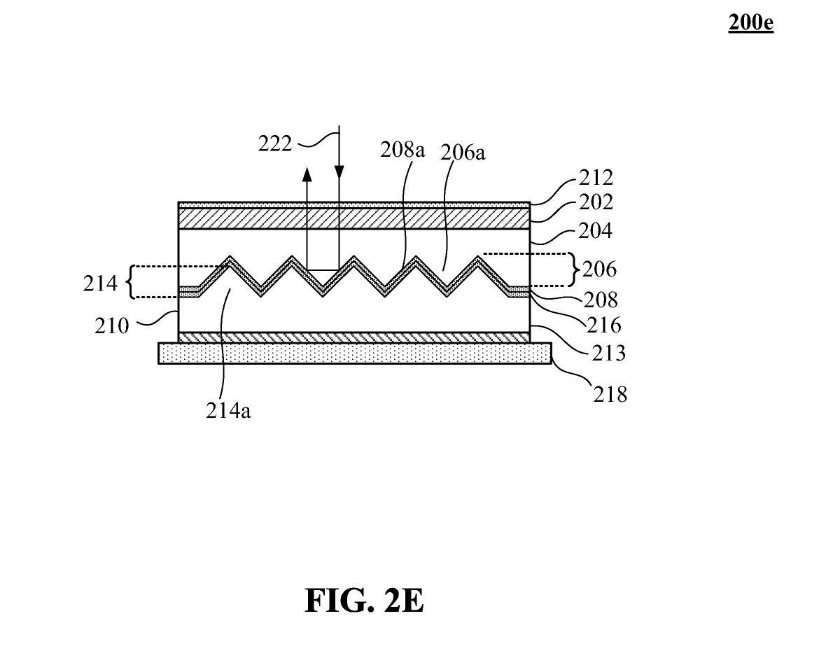

Please refer to FIG. 2A. FIG. 2A is a schematic cross-sectional view of an optical retroreflective apparatus 200a according to a first embodiment of the present invention. The optical retroreflective apparatus 200a is used to reflect an incident light 222 and includes a substrate 202, a first material layer 204, a first tape pattern layer 206, a reflecting layer 208, a second material layer 210, an anti-reflecting function layer 212 and an adhesive strip layer 213. The optical retroreflective apparatus 200a is bonded to the display frame 218 by the adhesive strip layer 213. In one embodiment, the material of the substrate 202 is polymer resin which is selected from one group consisting of polyethylene terephthalate (PET), polycarbonate, poly methylmethacrylate (PMMA), polyethylene (PE), polyvinyl chloride (PVC), polypropylene and the combinations thereof. The anti-reflecting function layer 212 may be an anti-reflecting coating layer having a multilayer film structure and/or micro structure to reduce the reflected light of the incident light 222 and increase the transmission rate of the incident light 222 to the optical retroreflective apparatus 200a. In another case, the anti-reflecting function layer may be anti-glare layer for scattering the reflected incident light 222 to reduce the glare light on the optical retroreflective apparatus 200a.

The first material layer 204 is formed on the substrate 202 and for example, the first material layer 204 is a hardened resin layer. The first taper pattern layer 206 is formed on the first material 204 wherein the first taper pattern layer 206 has a plurality of first pyramidal units 206a. The reflecting layer 208 is formed on the first taper pattern layer 206 and covers the first pyramidal units 206a wherein the reflecting layer 208 has a plurality of reflecting patterns 208a and each of the first pyramidal units 206a is covered with each of the reflecting patterns 208a. In one case, the material of the reflecting layer 208 is either aluminum or silver, or the material having higher reflecting rate in view of the incident light 222.

The second material layer 210 is formed on the reflecting layer 208 and the second material layer 210 has a second taper pattern layer 214 which is composed of a plurality of pyramidal units 214a. The reflecting layer 208 is covered with the second taper pattern layer 214 and the second pyramidal units 214a are correspondingly filled into the spacing region between the reflecting patterns 208a of the reflecting layer 208 for complementing the second pyramidal units 214a with the first pyramidal units 206a therebetween. In one embodiment, the first taper pattern layer 206 and the second taper pattern layer 214 are totally complementary so that the geometry shapes of the second pyramidal units 214a and the first pyramidal units 206a are entirely complementary. That is, the second pyramidal units 214a are completely and correspondingly embedded into the first pyramidal units 206a, as shown in FIG. 2A.

In one case, the material of the second material layer 210 is ultraviolet hardened resin or thermosetting plastic. The ultraviolet hardened resin is selected from one group consisting of epoxy resin, carbamate, polyethylene (PE), and polyester. Person skilled in the art should be noted that the taper pattern layer includes convex pyramid shape, concave pyramid shape and longitudinal prism shape on the substrate 202.

The anti-reflection function layer 212 is formed on the substrate 202, and the anti-reflection function layer 212 and the first material layer 204 are formed on the opposite sides of the substrate 202, respectively. The anti-reflecting function layer 212 is used to reduce the reflected light on the substrate 202 in the environment. When the incident light 222 is issued to the optical retroreflective apparatus 200a, the incident light 222 is transmitted to the anti-reflection function layer 212, the substrate 202 and the first material layer 204 sequentially and the reflecting patterns 208a of the reflecting layer 208 then reflects the transmitted incident light 222. Afterwards, the incident light 222 passes through the first material layer 204, the substrate 202 and the anti-reflection function layer 212 in a reverse direction so that the incident light 222 precisely reflects in the reverse direction which is opposite to the incident direction after the incident light 222 is reflected by the reflecting patterns 208a. Since the second material layer 210 is closely adhered to the first material layer 204, the optical retroreflective apparatus 200a is stably stuck to the display frame 218 of a touch screen to prevent the optical retroreflective apparatus 200a from the deformation. As a result, the reflected incident light can be used to detects the touch position on the touch screen when the reflecting layer 208 precisely reflects the incident light 222.

Please refer to FIG. 2B. FIG. 2B is a schematic cross-sectional view of an optical retroreflective apparatus 200b according to a second embodiment of the present invention. The optical retroreflective apparatus 200b is used to reflect an incident light 222 and includes a substrate 202, a first material layer 204, a first tape pattern layer 206, a reflecting layer 208, a second material layer 210, an anti-reflecting function layer 212 and an adhesive strip layer 213. The optical retroreflective apparatus 200b is bonded to the display frame 218 by the adhesive strip layer 213.

The first material layer 204 is formed on the substrate 202 and for example, the first material layer 204 is a hardened resin layer. The first taper pattern layer 206 is formed on the first material 204 wherein the first taper pattern layer 206 has a plurality of first pyramidal units 206a. The reflecting layer 208 is formed on the first taper pattern layer 206 and covers the first pyramidal units 206a wherein the reflecting layer 208 has a plurality of reflecting patterns 208a and each of the first pyramidal units 206a is covered with each of the reflecting patterns 208a.

The second material layer 210 is formed on the reflecting layer 208 and the second material layer 210 has a second taper pattern layer 214 which is composed of a plurality of pyramidal units 214a. The reflecting layer 208 is covered with the second taper pattern layer 214 and the second pyramidal units 214a are correspondingly filled into the spacing region between the reflecting patterns 208a of the reflecting layer 208 for complementing the second pyramidal units 214a with the first pyramidal units 206a therebetween to form the optical retroreflective apparatus 200b. In one embodiment, the first taper pattern layer 206 and the second taper pattern layer 214 are totally complementary so that the geometry shapes of the second pyramidal units 214a and the first pyramidal units 206a are entirely complementary. That is, the second pyramidal units 214a are completely and correspondingly embedded into the first pyramidal units 206a, as shown in FIG. 2B.

In one case, each of the first pyramidal units 206a of the first taper pattern layer 206 has a edge length “d1” from 10 nm to 200 nm and each of the second pyramidal units 214a of the second taper pattern layer 214 has a edge length “d2” from 10 nm to 200 nm. Preferably, each of the first pyramidal units 206a of the first taper pattern layer 206 has a edge length “d1” from 10 nm to 200 nm and each of the second pyramidal units 214a of the second taper pattern layer 214 has a edge length “d2” from 20 nm to 100 nm to have optimized optical characteristic, such as the reflecting angle of the incident light 222.

The anti-reflection function layer 212 is formed on the second material layer 210, and the anti-reflection function layer 212 and the first material layer 204 are formed on the same sides of the substrate 202, respectively. When the incident light 222 is issued to the optical retroreflective apparatus 200b, the incident light 222 is sequentially transmitted to the anti-reflection function layer 212 and the second material layer 210 and the reflecting patterns 208a of the reflecting layer 208 then reflects the transmitted incident light 222. Afterwards, the incident light 222 passes through the second material 210 and the anti-reflection function layer 212 in a reverse direction so that the incident light 222 precisely reflects in the reverse direction which is opposite to the incident direction after the incident light 222 is reflected by the reflecting patterns 208a. Since the second material layer 210 is closely adhered to the first material layer 204, the optical retroreflective apparatus 200b is stably stuck to the display frame 218 of a touch screen by the adhesive strip layer 213 to prevent the optical retroreflective apparatus 200b from the deformation. As a result, the reflected incident light can be used to detects the touch position on the touch screen when the reflecting layer 208 precisely reflects the incident light 222.

Please refer to FIG. 2C. FIG. 2C is a schematic cross-sectional view of an optical retroreflective apparatus 200c according to a third embodiment of the present invention. The optical retroreflective apparatus 200c is similar to the optical retroreflective apparatus 200a in FIG. 2A. The difference between the optical retroreflective apparatus 200a and optical retroreflective apparatus 200c is that the optical retroreflective apparatus 200c further includes a third material layer 220 which is formed on the second material layer 210 so that the second material layer 210 is closely adhered to the display frame 218 by the third material layer 220. In other words, the third material layer 220 is adhered to the display frame 218 in a flat and smooth form by using the adhesive strip layer 213 for stably combining the optical retroreflective apparatus 200c with the display frame 218.

When the incident light 222 is issued to the optical retroreflective apparatus 200c, the incident light 222 is transmitted to the anti-reflection function layer 212, the substrate 202 and the first material layer 204 sequentially and the reflecting patterns 208a of the reflecting layer 208 then reflects the transmitted incident light 222. Afterwards, the incident light 222 passes through the first material layer 204, the substrate 202 and the anti-reflection function layer 212 in a reverse direction so that the incident light 222 precisely reflects in the reverse direction which is opposite to the incident direction after the incident light 222 is reflected by the reflecting patterns 208a. Since the second material layer 210 is closely adhered to the first material layer 204, the optical retroreflective apparatus 200c is stably stuck to the display frame 218 of a touch screen to prevent the optical retroreflective apparatus 200c from the deformation. As a result, the reflected incident light can be used to detects the touch position on the touch screen when the reflecting layer 208 precisely reflects the incident light 222.

Please refer to FIG. 2D. FIG. 2D is a schematic cross-sectional view of an optical retroreflective apparatus 200d according to a fourth embodiment of the present invention. The optical retroreflective apparatus 200d is similar to the optical retroreflective apparatus 200b in FIG. 2B. The difference between the optical retroreflective apparatus 200b and optical retroreflective apparatus 200d is that the optical retroreflective apparatus 200d further includes a third material layer 220 which is formed between the second material layer 210 and the anti-reflection function layer 212 so that the first material layer 204 is closely adhered to the second material layer 210 by the third material layer 220.

When the incident light 222 is issued to the optical retroreflective apparatus 200d, the incident light 222 is transmitted to the anti-reflection function layer 212, the third material layer 220 and the second material layer 210 sequentially and the reflecting patterns 208a of the reflecting layer 208 then reflects the transmitted incident light 222. Afterwards, the incident light 222 passes through the second material layer 210, the third material layer 220 and the anti-reflection function layer 212 in a reverse direction so that the incident light 222 precisely reflects in the reverse direction which is opposite to the incident direction after the incident light 222 is reflected by the reflecting patterns 208a. Since the second material layer 210 is closely adhered to the first material layer 204, the optical retroreflective apparatus 200d is stably stuck to the display frame 218 of a touch screen by the adhesive strip layer 213 to prevent the optical retroreflective apparatus 200d from the deformation. As a result, the reflected incident light can be used to detects the touch position on the touch screen when the reflecting layer 208 precisely reflects the incident light 222.

In FIGS. 2C and 2D, the material of third material layer 220 is polymer resin which is selected from one group consisting of polyethylene terephthalate (PET), polycarbonate, poly methylmethacrylate (PMMA), polyethylene (PE), polyvinyl chloride (PVC), polypropylene and the combinations thereof.

Please refer to FIG. 2E. FIG. 2E is a schematic cross-sectional view of an optical retroreflective apparatus 200e according to a fifth embodiment of the present invention. The optical retroreflective apparatus 200e is used to reflect an incident light 222 and includes a substrate 202, a first material layer 204, a first tape pattern layer 206, a reflecting layer 208, a second material layer 210, an anti-reflecting function layer 212 and a bonding layer 216. The first material layer 204 is formed on the substrate 202 and for example, the first material layer 204 is a hardened resin layer. The first taper pattern layer 206 is formed on the first material 204 wherein the first taper pattern layer 206 has a plurality of first pyramidal units 206a. The reflecting layer 208 is formed on the first taper pattern layer 206 and covers the first pyramidal units 206a wherein the reflecting layer 208 has a plurality of reflecting patterns 208a and each of the first pyramidal units 206a is covered with each of the reflecting patterns 208a.

The second material layer 210 is formed on the reflecting layer 208 and the second material layer 210 has a second taper pattern layer 214 which is composed of a plurality of pyramidal units 214a. The reflecting layer 208 is covered with the second taper pattern layer 214 and the second pyramidal units 214a are correspondingly filled into the spacing region between the reflecting patterns 208a of the reflecting layer 208 for complementing the second pyramidal units 214a with the first pyramidal units 206a therebetween to from the optical retroreflective apparatus 200e. The bonding layer 26 is used to adhere the reflecting layer 208 to the second material layer 210. In one embodiment, the first taper pattern layer 206 and the second taper pattern layer 214 are partially complementary so that the geometry shapes of the second pyramidal units 214a and the first pyramidal units 206a are partially complementary. That is, the second pyramidal units 214a are partially embedded into the first pyramidal units 206a. The second material layer 210 is a plate layer having the second taper pattern layer 214. The material of the plate layer is ultraviolet hardened resin or thermosetting plastic. The ultraviolet hardened resin is selected from one group consisting of epoxy resin, carbamate, polyethylene (PE), and polyester.

The anti-reflection function layer 212 is formed on the substrate 202, and the anti-reflection function layer 212 and the first material layer 204 are formed on the opposite sides of the substrate 202, respectively. When the incident light 222 is issued to the optical retroreflective apparatus 200e, the incident light 222 is transmitted to the anti-reflection function layer 212, the substrate 202 and the first material layer 204 sequentially and the reflecting patterns 208a of the reflecting layer 208 then reflects the transmitted incident light 222. Afterwards, the incident light 222 passes through the first material layer 204, the substrate 202 and the anti-reflection function layer 212 in a reverse direction so that the incident light 222 precisely reflects in the reverse direction which is opposite to the incident direction after the incident light 222 is reflected by the reflecting patterns 208a. Since the second material layer 210 is closely adhered to the first material layer 204, the optical retroreflective apparatus 200e is stably stuck to the display frame 218 of a touch screen by the bonding layer 216 to prevent the optical retroreflective apparatus 200e from the deformation. As a result, the reflected incident light can be used to detects the touch position on the touch screen when the reflecting layer 208 precisely reflects the incident light 222.

According to the above-mentioned descriptions, the bonding status between the first material layer 204 and the second material layer 210 is performed by adhering the first taper pattern layer 206 and the reflecting layer 208 to the second taper pattern layer 208. Specifically, the geometry shapes of the first pyramidal units 206a, reflecting patterns 208a and the second pyramidal units 208a are complementary so that first material layer 204 stably secured to the second material layer 210 to improve the stability of the optical retroreflective apparatuses (200a, 200b, 200c, 200d, and 200e) adhered to the display frame 218 of the display device to prevent the optical retroreflective apparatuses (200a, 200b, 200c, 200d, and 200e) from the deformation. Furthermore, the conventional technique utilizes the vertexes of the pyramidal units which have smaller contact region, however, the optical retroreflective apparatuses (200a, 200b, 200c, 200d, and 200e) in the present invention effectively increase the contact region between the first pyramidal units 206a, the reflecting patterns 208a and the second pyramidal units 214a for improving the secured stability of the first material layer 204 to the second material layer 210. In addition, the second material layer 210 is bonded to the reflecting layer 208 to prevent reflecting patterns 208a from oxidation. Therefore, when the optical retroreflective apparatuses (200a, 200b, 200c, 200d, and 200e) are adhered to the display frame 218, the reflecting layer 208 between the first material layer 204 and the second material layer 210 are protected from deformation so that the incident light 222 precisely reflects in the reverse direction which is opposite to the incident direction after the incident light 222 is reflected by the reflecting patterns 208a.

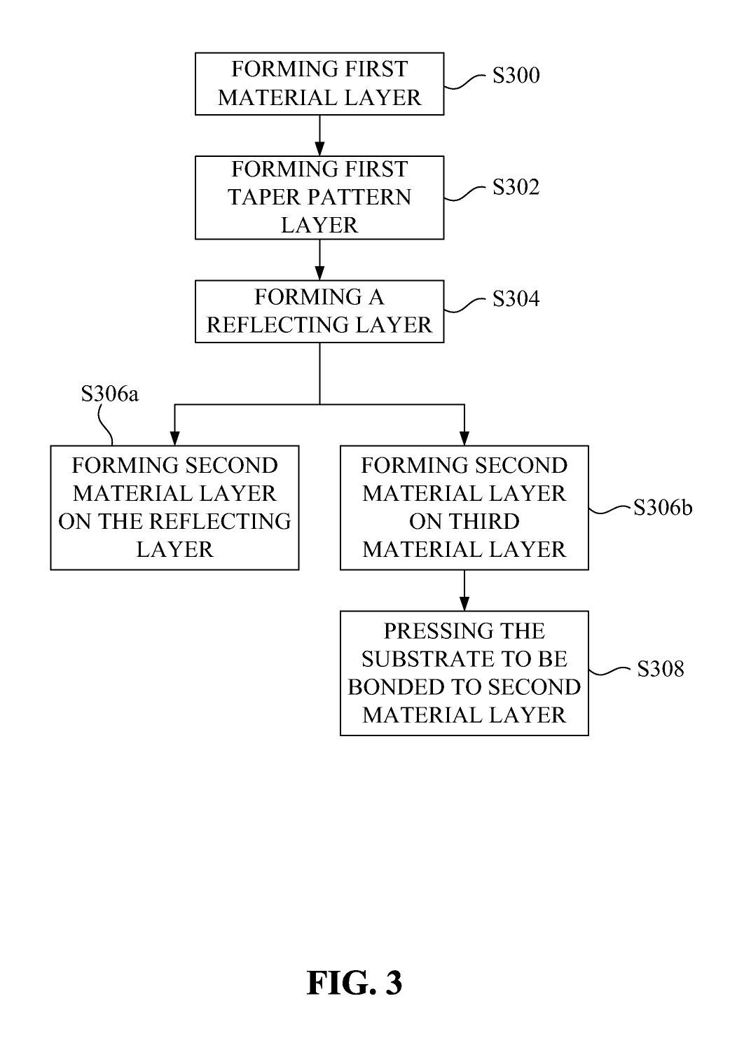

Please refer to FIGS. 2A, 2B, 2C, 2D and 3. FIG. 3 is a flow chart of manufacturing method of the optical retroreflective apparatuses (200a, 200b, 200c, 200d, and 200e) shown in FIGS. 2A-2D according to one embodiment of the present invention. The optical retroreflective apparatuses (200a, 200b, 200c, 200d, and 200e) include a substrate 202, a first material layer 204, a first tape pattern layer 206, a reflecting layer 208, a second material layer 210, an anti-reflecting function layer 212 and an adhesive strip layer 213. The manufacturing method includes the following steps.

In step S300, the first material layer 204 is formed on the substrate 202. For example, the first material layer 204 is a hardened resin layer.

In step S302, the first taper pattern layer 206 is formed on the first material 204 wherein the first taper pattern layer 206 has a plurality of first pyramidal units 206a. In one case, the hardened resin layer of the first material layer 204 is hardened by employing the ultraviolet.

In step S304, the reflecting layer 208 is formed on the first taper pattern layer 206 and covers the first pyramidal units 206a wherein the reflecting layer 208 has a plurality of reflecting patterns 208a and each of the first pyramidal units 206a is covered with each of the reflecting patterns 208a.

In FIGS. 2A and 2B, step S306a is performed and the second material layer 210 is formed on the reflecting layer 208 and the second material layer 210 has a second taper pattern layer 214 which is composed of a plurality of pyramidal units 214a. The reflecting layer 208 is covered with the second taper pattern layer 214 and the second pyramidal units 214a are correspondingly filled into the spacing region between the reflecting patterns 208a of the reflecting layer 208 for complementing the second pyramidal units 214a with the first pyramidal units 206a therebetween.

In first case, the adhesive strip layer 213 is formed on the second material layer 210 to construct the optical retroreflective apparatus 200a, as shown in FIG. 2A. In second case, the adhesive strip layer 213 is formed on the substrate 202 to construct the optical retroreflective apparatus 200b, as shown in FIG. 2B.

In FIGS. 2C and 2D, step S306b is performed and the second material layer 210 is formed on the third material layer 220.

In step S308, the substrate 202 including the first tape pattern layer 206 and the first material layer 206 is pressed and bonded to fit the second material layer 210 for forming the second taper pattern layer 214 of the second material layer 210. The second taper pattern layer 214 is composed of a plurality of pyramidal units 214a. The reflecting layer 208 is covered with the second taper pattern layer 214 and the second pyramidal units 214a are correspondingly filled into the spacing region between the reflecting patterns 208a of the reflecting layer 208 for complementing the second pyramidal units 214a with the first pyramidal units 206a therebetween. In one embodiment, the second material layer 210 is used to pack and roll the first tape pattern layer 206 of the first material layer 204 so that the first material layer 204 is fill and level up. For example, the hardened resin layer of the first material layer 204 is hardened by employing the ultraviolet for bonding the first material layer 204 and the second material layer 210.

Since the hardened resin layer of the first material layer 204 is hardened by employing the ultraviolet, the first material layer 204 is softened. Thus, after the third material layer 220 is formed, the adhesive strip layer 213 is formed to increase the security stability.

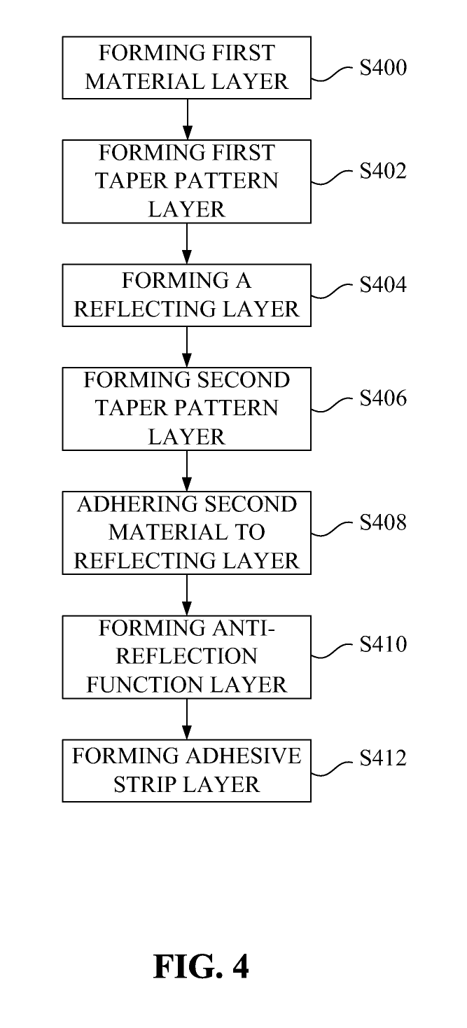

Please refer to FIGS. 2E and 4. FIG. 4 is a flow chart of manufacturing method of the optical retroreflective apparatus 200e shown in FIG. 2E according to one embodiment of the present invention. The optical retroreflective apparatus 200e includes a substrate 202, a first material layer 204, a first tape pattern layer 206, a reflecting layer 208, a second material layer 210, an anti-reflecting function layer 212 and a bonding layer 216. The manufacturing method includes the following steps.

In step S400, the first material layer 204 is formed on the substrate 202. For example, the material of the substrate 202 is polymer resin.

In step S402, the first taper pattern layer 206 is formed on the first material 204 wherein the first taper pattern layer 206 has a plurality of first pyramidal units 206a.

In step S404, the reflecting layer 208 is formed on the first taper pattern layer 206 and covers the first pyramidal units 206a wherein the reflecting layer 208 has a plurality of reflecting patterns 208a and each of the first pyramidal units 206a is covered with each of the reflecting patterns 208a. In one case, the material of the reflecting layer 208 is either aluminum or silver, or the material having higher reflecting rate, 90%, in view of the incident light 222.

In step S406, the second taper pattern layer 214 is formed on the second material layer 210 wherein the second taper pattern layer 214 has a plurality of pyramidal units 214a. In first case, the pyramidal units 214a, e.g. convex pyramid shape or concave pyramid shape, of the second taper pattern layer 214 are formed by an emboss step of a casting mold. In second case, the pyramidal units 214a, e.g. convex pyramid shape or concave pyramid shape, of the second taper pattern layer 214 are formed by a flat casting mold. In third case, the pyramidal units 214a, e.g. convex pyramid shape or concave pyramid shape, of the second taper pattern layer 214 are formed by a lithography and etching techniques. The second material layer 210 is a plate layer having the second taper pattern layer 214. The material of the plate layer is ultraviolet hardened resin or thermosetting plastic.

The geometry shapes of the second pyramidal units 214a and the first pyramidal units 206a are complementary. In one case, the first taper pattern layer 206 and the second taper pattern layer 214 are totally complementary so that the geometry shapes of the second pyramidal units 214a and the first pyramidal units 206a are entirely complementary, as shown in FIG. 2E. In another case, the first taper pattern layer 206 and the second taper pattern layer 214 are partially complementary so that the geometry shapes of the second pyramidal units 214a and the first pyramidal units 206a are partially complementary.

In step S408, the bonding layer 216 is used to adhere the second material 210 having the second taper pattern layer 214 to the reflecting layer 208 so that is the reflecting patterns 208a covered with the second taper pattern layer 214 and the second pyramidal units 214a are correspondingly filled into the spacing region between the first pyramidal units 206a.

In step S410, the anti-reflection function layer 212 is formed on the substrate 202. The anti-reflection function layer 212 and the first material layer 202 are formed on the opposite sides of the substrate 202, respectively.

In step S412, the adhesive strip layer 213 is formed on the second material layer 210.

According to the above-mentioned descriptions, the bonding status between the first material layer 204 and the second material layer 210 is performed by adhering the first taper pattern layer 206 and the reflecting layer 208 to the second taper pattern layer 208. Specifically, the geometry shapes of the first pyramidal units 206a, reflecting patterns 208a and the second pyramidal units 208a are complementary so that first material layer 204 stably secured to the second material layer 210 to improve the stability of the optical retroreflective apparatuses (200a, 200b, 200c, 200d, and 200e) adhered to the display frame 218 of the display device to prevent the optical retroreflective apparatuses (200a, 200b, 200c, 200d, and 200e) from the deformation. Furthermore, the conventional technique utilizes the vertexes of the pyramidal units which have smaller contact region, however, the optical retroreflective apparatuses (200a, 200b, 200c, 200d, and 200e) in the present invention effectively increase the contact region between the first pyramidal units 206a, the reflecting patterns 208a and the second pyramidal units 214a for improving the secured stability of the first material layer 204 to the second material layer 210.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An optical retroreflective apparatus, comprising:
a substrate;
a first material layer, formed on the substrate;
a first taper pattern layer, formed on the first material wherein the first taper pattern layer has a plurality of first pyramidal units;
a reflecting layer, formed on the first taper pattern layer and covering the first pyramidal units wherein the reflecting layer has a plurality of reflecting patterns and each of the first pyramidal units is covered with each of the reflecting patterns; and
a second material layer, formed on the reflecting layer and having a second taper pattern layer which is composed of a plurality of pyramidal units wherein the reflecting layer is covered with the second taper pattern layer and the second pyramidal units are correspondingly filled into the spacing region between the reflecting patterns of the reflecting layer for complementing the second pyramidal units with the first pyramidal units therebetween.

2. The optical retroreflective apparatus of claim 1, wherein the material of the substrate is polyethylene terephthalate (PET).

3. The optical retroreflective apparatus of claim 1, wherein the first material layer is a hardened resin layer.

4. The optical retroreflective apparatus of claim 1, wherein each of the first pyramidal units of the first taper pattern layer has a edge length from 10 nm to 200 nm and each of the second pyramidal units of the second taper pattern layer has a edge length from 10 nm to 200 nm.

5. The optical retroreflective apparatus of claim 1, wherein the material of the reflecting layer is either aluminum or silver.

6. The optical retroreflective apparatus of claim 1, further comprising a anti-reflection function layer which is formed on the substrate, and the anti-reflection function layer and the first material layer are formed on the opposite sides of the substrate, respectively.

7. The optical retroreflective apparatus of claim 1, wherein the first taper pattern layer and the second taper pattern layer are totally complementary.

8. The optical retroreflective apparatus of claim 1, wherein the first taper pattern layer and the second taper pattern layer are partially complementary.

9. The optical retroreflective apparatus of claim 1, wherein the material of the second material layer is ultraviolet hardened resin or thermosetting plastic.

10. The optical retroreflective apparatus of claim 9, further comprising an adhesive strip layer which is formed on the second material layer.

11. The optical retroreflective apparatus of claim 9, further comprising an adhesive strip layer which is formed on the substrate.

12. The optical retroreflective apparatus of claim 1, further comprising a third material layer which is formed on the second material layer.

13. The optical retroreflective apparatus of claim 12, wherein the second material layer is a plate layer having the second taper pattern layer.

14. The optical retroreflective apparatus of claim 13, further comprising a bonding layer for adhering the reflecting layer to the second material layer.

15. The optical retroreflective apparatus of claim 14, wherein the material of the third material layer is polyethylene terephthalate (PET).

16. A method of forming an optical retroreflective apparatus, the method comprising the steps of:
(a) forming a first material layer on a substrate;
(b) forming a first taper pattern layer on the first material wherein the first taper pattern layer has a plurality of first pyramidal units;
(c) forming a reflecting layer on the first taper pattern layer for covering the first pyramidal units wherein the reflecting layer has a plurality of reflecting patterns and each of the first pyramidal units is covered with each of the reflecting patterns; and
(d) forming a second material layer having a second taper pattern layer which is composed of a plurality of pyramidal units, and the reflecting layer is covered with the second taper pattern layer and the second pyramidal units are correspondingly filled into the spacing region between the reflecting patterns of the reflecting layer for complementing the second pyramidal units with the first pyramidal units therebetween.

17. The method of claim 16, during the step (d), further comprising a step of: (d1) forming the second material layer on the reflecting layer.

18. The method of claim 16, during the step (d), further comprising a step of: (d2) forming the second material layer on a third material layer.

19. The method of claim 16, after the step of (d2), further comprising a step of: (d3) pressing the substrate including the first tape pattern layer and the first material layer to be bonded to the second material layer.

20. A method of forming an optical retroreflective apparatus, the method comprising the steps of:
forming a first material layer on the substrate;
forming a first taper pattern layer on the first material wherein the first taper pattern layer has a plurality of first pyramidal units;
forming a reflecting layer on the first taper pattern layer for covering the first pyramidal units wherein the reflecting layer has a plurality of reflecting patterns and each of the first pyramidal units is covered with each of the reflecting patterns;
forming a second taper pattern layer on the second material layer wherein the second taper pattern layer has a plurality of pyramidal units;
adhering the second material having the second taper pattern layer to the reflecting layer by a bonding layer;
forming an anti-reflection function layer on the substrate; and
forming an adhesive strip layer on the second material layer.
